(19) United States
(12) Patent Application Publication
(10) Pub. No.: US 2004/0173405 A1
(43) Pub. Date: Sep. 9, 2004

(54) Safety device for operations on horizontal surfaces in construction works

(76) Inventor: Pedro Xammar Bove, Montcada i Reixac (ES)

Correspondence Address: SUGHRUE MION, PLLC, 2100 PENNSYLVANIA AVENUE, N.W., SUITE 800, WASHINGTON, DC, 20037, US

(21) Appl. No.: 10/479,588

(22) PCT Filed: May 17, 2002
(86) PCT No.: PCT/ES02/00233

(30) Foreign Application Priority Data
Jun. 4, 2001 (ES) P200101283

(51) Int. Cl. A62B 37/00

(52) U.S. Cl. 182/3

(57) ABSTRACT

It comprises fastening means of an operator to a fixed part of the construction, which include a harness or safety belt and a snap link; an anchorage element (2), adapted for being inserted into a mass of concrete (3) and remaining solidified to the same after setting, which links the device to said fixed part of the construction; and a stanchion (4) movably coupled at its lower part to said anchorage element and joined at its upper part to a rope (5) which, at its lower end (7) is linked to the said fastening means, and which can turn with respect to the vertical axis (8) of the stanchion. Once the concrete has set, the operator remains firmly fastened with the possibility of moving freely within an essentially circular field of action (24), around said vertical axis.

Particularly applicable to safety for work on horizontal formworks.

### TECHNICAL SECTOR OF THE INVENTION

The present invention relates to a safety device for work on horizontal surfaces in construction works, of the type comprising fastening means of an operator to a fixed part of the construction, which include a harness or safety belt and a snap link; anchorage means which link the device to said fixed part of the construction; and joining means of said fastening means to said anchorage means.

### BACKGROUND TO THE INVENTION

One of the most frequent risks in the construction sector in work carried out high up is that of falls, particularly that applying to the case of formwork preparation for horizontal surfaces, slabs, level beams, etc.

A good number of systems are known in the form of individual protection equipment which have been envisaged to avoid risks in this type of work, such as fastening an operator to a fixed part through a harness or safety belt and joined by means of a snap link to one end of a rope of limited length linked to the fixed part by its opposite end.

By way of collective protective equipment, devices are known which frequently include a netting that wholly or partly surround the perimeter of the horizontal surface which is being worked on.

The individual protective equipment consisting of currently known harnesses have the disadvantage that, while they prevent the fall, they excessively limit the operator's movement. As far as equipment based on netting is concerned, it suffers from the drawback of not preventing the fall, being limited to avoiding falls to the ground and it seldom avoids blows and knocks to the person who falls.

Document EP-A-1083273 discloses D2, discloses an accident-prevention device which comprises at least one pole and elements for detachably and fixedly connecting the base of the pole to the surface of a building, the pole having wings rigidly fixed to the lateral surface of a sleeve which is supported by the tip element so that said sleeve can rotate about its own axis.

The purpose of the present invention is to provide a device of the aforementioned type which is free of such drawbacks and is easier to install and very comfortable and simple to use.

### EXPLANATION OF THE INVENTION

To do so, the object of the present invention is a safety device for work on horizontal surfaces in construction works, novel in concept and functionality, in which the anchorage means are made up of an anchorage element, suitable for being inserted into a mass of concrete or mortar in a fluid state, and remaining solidified to the same after the setting or hardening of said mass. The safety device is essentially characterised in that the joining means are made up of a stanchion, movably coupled at its lower part to said anchorage element and with the possibility of pivoting on its vertical axis, and joined, at its upper part, to the upper end of a rope which, at its lower end, is linked to a fastening means, the rope being able to turn with respect to the vertical axis of the stanchion, all adapted in such a way that the operator remains firmly fastened with the possibility of moving freely within an essentially circular field of action, around said vertical axis.

According to another feature of the invention, the anchorage element is a sleeve which receives in its interior the lower end of the stanchion with the possibility of pivoting on its vertical axis.

According to another feature of the device of the present invention, the sleeve has an inverted truncated cone shape and comprises a perimeter rim envisaged for resting on the outer surface of the mass of concrete or mortar, offering the possibility of recuperating it after use.

Alternatively, the anchorage element of the present invention can be a solid block fitted with an upper rod which projects from the mass of concrete or mortar and which receives the coupling from a hollow tubular lower portion of the stanchion, with the possibility of turning around its vertical axis.

According to a variation of the present invention, the stanchion is a pole, preferably having a certain amount of flexibility.

According to an alternative form of embodiment of the anchorage means of the invention, the same comprises at least one strap hinge integral to a flat plate which is inserted horizontally into the mass of concrete so that the strap hinge remains vertical for the anchorage of the stanchion.

According to an embodiment of the joining means, the same also comprises an upper turning member, joined to the stanchion, with the possibility of turning with respect to the latter on its vertical axis.

In the invention it is envisaged that said upper turning member comprises a turning arm into the free end of which is fixed the upper end of the rope.

The device may comprise an arm fitted with a fixed or moveable compensating ballast in the opposite end of the turning arm.

Preferably, the rope comprises energy absorbing means, adapted for preventing the operator from suffering an impact by the jerking of the rope in the event of an accidental fall.

According to another form of embodiment of the present invention, at its lower end the device comprises a fastening for a hoisting hook by means of a crane hook or similar device, essentially arranged about the centre of mass of the device.

Preferably, the mass of concrete or mortar is the upper end of a pillar or column of a construction work.

When the section of the pillar or the column is limited, it has been envisaged that the device be provided with a perimeter metal hoop adapted for being fixed to the outside of the pillar or column and that it is fitted with a sleeve for anchoring the stanchion.

### BRIEF DESCRIPTION OF THE DRAWINGS

Below a preferred, although not exclusive, form of embodiment of the present invention is described with accompanying drawings to aid comprehension and given merely by way of non-limiting example, in which:

FIG. 1 is a section view of a first variation of the anchorage means;

FIG. 2 is a perspective view of a second variation of the anchorage means;

FIGS. 3 to 5 are elevation views illustrating respective forms of embodiment of the device according to the invention;

FIG. 6 is a plan view illustrating the operating mode of the device according to the invention;

FIGS. 7 to 12 illustrate other alternative variations of the anchorage means;

FIG. 13 is a perspective view illustrating the constitution and mode of use of another variation of the device according to the invention;

FIGS. 14 and 15 are two other embodiment examples of the device of the invention.

### DETAILED DESCRIPTION OF THE DRAWINGS

In said drawings it can be seen that the safety device for work on horizontal surfaces 17 in construction works comprises:

fastening means of an operator, represented as 31, to a fixed element of the construction, such as a column 21,

anchorage means which link the device 1 to the column 21;

joining means of said fastening means to said anchorage means.

The device 1 of the invention constitutes protective equipment intended for preventing accidental falls from high up in construction works, especially applicable to the case of formwork 23 preparation for horizontal surfaces 17 of slabs, level beams, etc.

The device 1 of the invention, as well as preventing falls, enables the operators to enjoy the benefit of a relatively extensive field of action, having great freedom of movement, represented with the reference 24.

The said fastening means includes a safety harness or belt and a snap link for the operator 31 who, for the purposes of clarity and because they are already well known, have not been represented in the drawings.

As a novel feature and characteristic of the invention, the anchorage means are made up of an anchorage element, adapted for being inserted in a mass of concrete 3 or mortar in a fluid state and remaining integral to the same after setting or hardening.

Equally novel is the constitution of the joining means, which are formed by a stanchion 4 moveably coupled at its lower part to said anchorage element 2, and joined at its upper part to the upper end 6 of a rope 5.

The rope 5 is linked at its lower end 7 to the operator 31 through said fastening means, and may turn with respect to the vertical axis 8 of the stanchion 4.

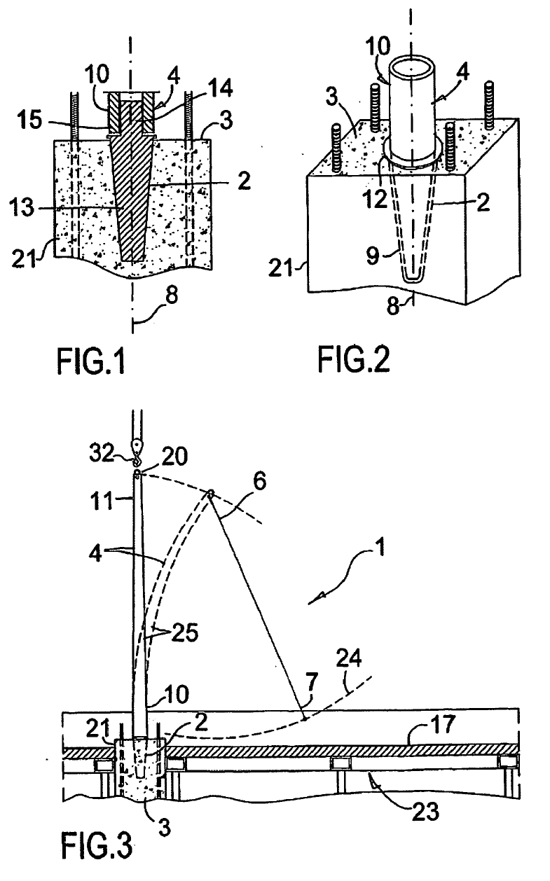

In FIG. 1 a variation of the anchorage element 2 is represented wherein the latter is made up of a solid block 13 and is inserted into the mass of concrete 3 in a fluid state when poured into a formwork for columns. The block 13 has an upper rod 14 which projects from the mass of concrete 3 and which is adapted for receiving, with the possibility of rotation on a vertical axis 8, a lower hollow tubular portion 15 of the stanchion 4.

In FIG. 2 another variation of the anchorage element 2 is represented, which in this case adopts the shape of a hollow sleeve 9 with an inverted frustoconical shape that receives in its interior the lower end 10 of the stanchion 4, with the possibility of pivoting on its vertical axis 8. The sleeve 9 is inserted into the upper end of the concrete 3 resting on the concrete mass 3, for example through a perimeter rim 12.

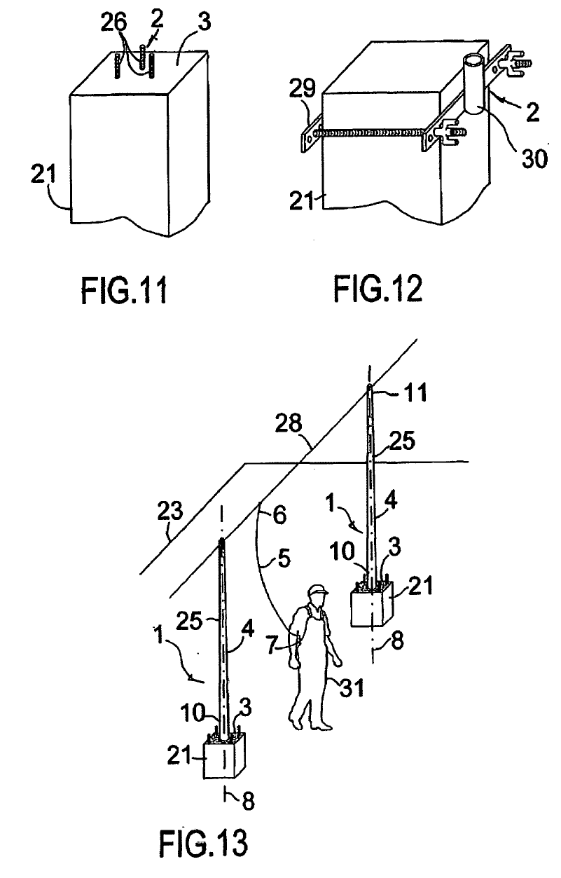

In FIGS. 7 to 11 other alternative variations of the anchorage means 2 are shown, provided for when the section of the column 21 does not permit the utilisation of the solid block 13 with the rod 14 or sleeve 9. In this case, they comprise at least several strap hinges 26 intended for being anchored in the concrete mass 3, either directly (FIG. 11) or through a flat plate 27 (FIGS. 7 to 10) which is inserted horizontally into the concrete mass 3 and remains fixed to the latter after setting, in such a way that the strap hinge or hinges 26 remain vertical. These cases are designed for anchoring a stanchion 4, fitted with a lower hollow tubular portion 15, in a way similar to the anchorage 2 of FIG. 1.

In FIG. 12 yet another variation of the anchorage means 2 is represented, which in this case comprise a perimeter metal hoop 29 which is fixed around the column 21 and which is fitted with a sleeve 30 for the anchorage of the stanchion 4.

In FIGS. 3 and 13 an embodiment example of the stanchion 4 is shown in which the latter adopts the shape of pole 25, preferably having a certain amount of flexibility.

As a result, once the concrete 3 has set, the operator remains firmly fastened to column 21, although with the possibility of moving freely above the formwork 23, within an essentially circular field of action 24, centred on the post 4.

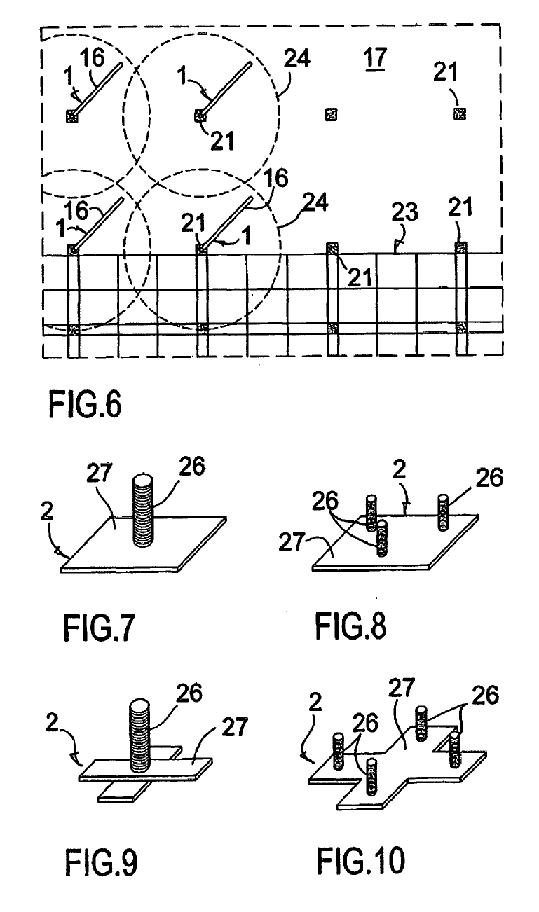

The application of the protective device 1 of the invention is illustrated in FIGS. 6 and 13. FIG. 6 represents a plan view of a slab at construction phase by means of a formwork 23, from which multiple columns project. Some columns 21 incorporate the device 1 of the invention, their respective fields of action 24 having been represented. The operator 31 can move over the horizontal surface 17 in complete safety and comfort just by fastening and releasing the fastening means (harness and/or snap link) which link it to the stanchion 4.

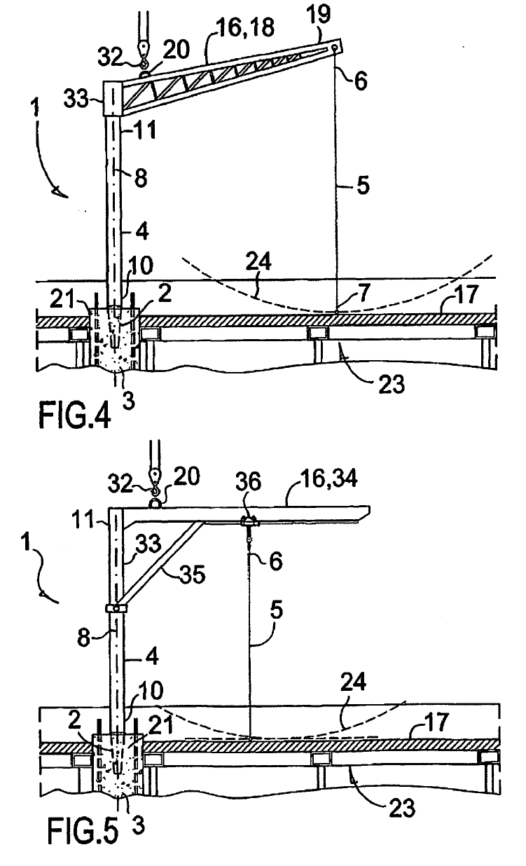

In FIGS. 4, 5, 14 and 15 embodiments of the safety device 1 of the present invention have been represented in which the joining means comprise an upper turning member 16, joined by means of an articulation 33 to the stanchion 4 with the possibility of turning on the vertical axis 8 of the latter.

In the case of the FIGS. 4, 14 and 15, said upper turning member 16 comprises a turning arm 18 at whose free end 19 the upper end 6 of the rope 5 is fixed.

In the case of FIG. 5, it is a beam 34 with a bracket 35, along which a sliding carriage 36 slides horizontally and receives the coupling of the upper end 6 of the rope 5. In this case, to the field of action 24 of the operator 31 around the stanchion 4 can be added the possibility of horizontal movement determined by the route of the sliding carriage 36.

Preferably, in all cases, the rope 5 comprises energy absorbing means, adapted for preventing the operator 31 from suffering an impact from a jerk on the rope 5 in the case of an accidental fall. These energy absorbing means can be any disclosed type, for example a spring located between the lower end 7 of the rope 5 and the harness or snap link (not shown) attached to the operator 31.

Similarly in a preferred form, whatever the form of embodiment of the anchorage, fastening and joining means of the safety device 1 of the present invention, it comprises at its upper part, near the upper end 11 of the stanchion 4, a fastening 20 for a hoisting hook by means of a crane hook 32 or analogous device, essentially arranged on the centre of mass of the device 1 (FIGS. 3, 4 and 5)

In FIG. 13 an embodiment example of the device is shown in which several stanchions 4 are linked by a cable 28 to which the rope 5 is coupled with the possibility of sliding in order to provide a greater field of action to the operator 31.

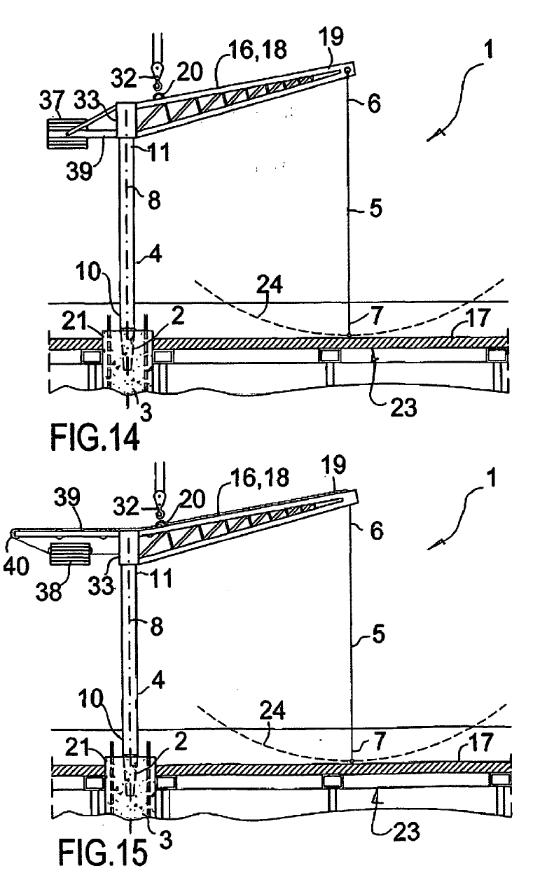

Illustrated in FIGS. 14 and 15 are both cases in which the upper turning member 16 comprises, as well as the said turning arm 18, an opposite arm 39 with a ballast 37, 38 that counteracts the weight of the operator 31 who is temporarily fastened to the device. In the case of FIG. 14, the ballast is a fixed ballast 37. In FIG. 15 it is a mobile ballast 38, integral to the rope 5 and which turns around an end pulley 40 integral to the opposite arm 39 so that, when a temporarily tied operator 31 tends to fall to one side, pulling the rope 5, the latter turns on the pulley 40, making the ballast 38 move away from the end of the rope 5 to which the operator 31 is tied, thus compensating the effect of his fall.

The nature of the present invention having been sufficiently described, as well as how to put it into practice, it is herein pointed out that the technical equivalents of the different elements can be subject to variations in detail, the main points being summarised in the following claims.

1. Safety device (1) for work on horizontal surfaces (17) in construction works, this safety device comprising fastening means of an operator to a fixed part of the construction, which fastening means include a harness or safety belt and further include a snap link; the safety device further comprises anchorage means, made up of an anchorage element (2) suitable for being inserted into a mass of concrete (3) or mortar in a fluid state, and remaining solidified to the same after the setting or hardening of said mass, said anchorage element linking the safety device to said fixed part of the construction; and joining means for joining said fastening means to said anchorage element, characterised in that the joining means are made up of a stanchion (4) movably coupled at its lower part to said anchorage element with the possibility of pivoting on its vertical axis (8), the stanchion (4) being joined at its upper part to the upper end (6) of a rope (5) which, at its lower end (7) is linked to the said fastening means, the rope being able to turn with respect to the vertical axis (8) of the stanchion such that the operator remains firmly fastened with the possibility of moving freely within an essentially circular field of action (24), around said vertical axis.

2. Device (1) according to claim 1, characterised in that the anchorage element (2) is a sleeve (9) which receives in its interior the lower end (10) of the stanchion (4) with the possibility of pivoting on its vertical axis (8).

3. Device (1) according to claim 2, characterised in that the sleeve (9) has an inverted truncated cone shape and comprises a perimeter rim (12) envisaged for resting on the outer surface of the mass of concrete (3) or mortar.

4. Device (1) according to claim 1, characterised in that the anchorage element (2) is a sold block (13) fitted with an upper rod (14) which projects from the mass of concrete (3) or mortar and which receives the coupling from a hollow tubular lower portion (15) of the stanchion (4), with the possibility of turning around its vertical axis (8).

5. Device (1) according to any of the previous claims, characterised in that the stanchion (4) is a pole (25), preferably having a certain amount of flexibility.

6. Device (1) according to claim 1, characterised in that the anchorage means comprise at least one strap hinge (26) integral to a flat plate (27) which is inserted horizontally into the mass of concrete (3) so that the strap hinge remains vertical for the anchorage of the stanchion (4).

7. Device (1) according to any of the previous claims, characterised in that the joining means also comprise an upper turning member (16), joined to the stanchion (4) with the possibility of turning with respect to the latter on its vertical axis (8).

8. Device (1) according to claim 7, characterised in that said upper turning member (16) comprises a turning arm (18) into the free end (19) of which is fixed the upper end (6) of the rope (5).

9. Device (1) according to claim 8, characterised in that it comprises an arm (39) fitted with a fixed (37) or moveable (38) compensating ballast in the opposite end of the turning arm (18).

10. Device (1) according to any of the previous claims characterised in that the rope (5) comprises energy absorbing means, adapted for preventing the operator from suffering an impact by the jerking of the rope in the event of an accidental fall.

11. Device (1) according to any of the previous claims, characterised in that it comprises at its upper part a fastening (20) for a hoisting hook by means of a crane hook or similar device, essentially arranged about the centre of mass of the device.

12. Device (1) according to any of the previous claims, characterised in that the mass of concrete (3) or mortar is the upper end of a pillar or column (21) of a construction work.

13. Device (1) according to claim 12, characterised in that it also comprises a perimeter metal hoop (29) adapted for being fixed to the outside of the pillar or column (21) and that is fitted with a sleeve (30) for anchoring the stanchion (4).
